(19) United States
(12) Patent Application Publication
(10) Pub. No.: US 2022/0027145 A1
(43) Pub. Date: Jan. 27, 2022

(54) CLOUD-BASED DYNAMIC PLUGIN DISTRIBUTION

(71) Applicant: Dell Products L.P., Round Rock, TX (US)

(72) Inventors: Harvey WANG, Shanghai (CN); Muzhar S. KHOKHAR, Shrewsbury, MA (US); Wenfeng LI, Shanghai (CN); Haijun ZHONG, Shanghai (CN)

(73) Assignee: Dell Products L.P., Round Rock, TX (US)

(21) Appl. No.: 16/937,031

(22) Filed: Jul. 23, 2020

(51) Int. Cl. G06F 8/658; G06F 8/71; G06F 9/50; H04L 29/06

(52) U.S. Cl. CPC G06F 8/658; H04L 63/0209; G06F 9/5072; G06F 8/71

(57) ABSTRACT

An information handling system may include at least one processor and a non-transitory memory coupled to the at least one processor. The information handling system may be configured to: provide an administrator with access to a patch management system via a patch service portal; receive information from a target datacenter regarding a particular item of software executing at the target datacenter; based on the received information, determine that an upgrade from an existing version to a new version of the particular item of software is available; and deploy the upgrade from the patch management system to a selected subset of information handling systems within the target datacenter, such that the selected subset is upgraded to the new version, and such that a non-selected subset of the information handling systems within the target datacenter continues executing the existing version.

### TECHNICAL FIELD

The present disclosure relates in general to information handling systems, and more particularly to the management of information handling systems such as server information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware° vSphere° ESXi™ environment, or any other HCI management system).

Updating the software of such an HCI system can involve delivering a large software package containing all of the updated components. However, this may hinder the adoption of new software versions by customers, as the monolithic software upgrade package takes a long time to develop, deliver, and upgrade the whole system. Further, this process may be somewhat error-prone.

But in many cases, only a single subsystem (or a small number of subsystems) may need to be upgraded, or some critical defect may need to be patched quickly for all users. For example, in systems using microservices, it may be the case that only a small patch is required for a particular microservice. In addition to updating existing components, it would also be advantageous for customers to be able to adopt new features or patches quickly.

Accordingly, embodiments of this disclosure may allow for simpler and more efficient updating of services, particularly in an HCI environment.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with the management of server information handling systems may be reduced or eliminated.

In accordance with embodiments of the present disclosure, an information handling system may include at least one processor and a non-transitory memory coupled to the at least one processor. The information handling system may be configured to: provide an administrator with access to a patch management system via a patch service portal; receive information from a target datacenter regarding a particular item of software executing at the target datacenter; based on the received information, determine that an upgrade from an existing version to a new version of the particular item of software is available; and deploy the upgrade from the patch management system to a selected subset of information handling systems within the target datacenter, such that the selected subset is upgraded to the new version, and such that a non-selected subset of the information handling systems within the target datacenter continues executing the existing version.

In accordance with these and other embodiments of the present disclosure, a method may include an information handling system providing an administrator with access to a patch management system via a patch service portal; the information handling system receiving information from a target datacenter regarding a particular item of software executing at the target datacenter; based on the received information, the information handling system determining that an upgrade from an existing version to a new version of the particular item of software is available; and the information handling system deploying the upgrade from the patch management system to a selected subset of information handling systems within the target datacenter, such that the selected subset is upgraded to the new version, and such that a non-selected subset of the information handling systems within the target datacenter continues executing the existing version.

In accordance with these and other embodiments of the present disclosure, an article of manufacture may include a non-transitory, computer-readable medium having computer-executable code thereon that is executable by an information handling system for: providing an administrator with access to a patch management system via a patch service portal; receiving information from a target datacenter regarding a particular item of software executing at the target datacenter; based on the received information, determining that an upgrade from an existing version to a new version of the particular item of software is available; and deploying the upgrade from the patch management system to a selected subset of information handling systems within the target datacenter, such that the selected subset is upgraded to the new version, and such that a non-selected subset of the information handling systems within the target datacenter continues executing the existing version.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of an update distribution system, in accordance with embodiments of the present disclosure.

### DETAILED DESCRIPTION

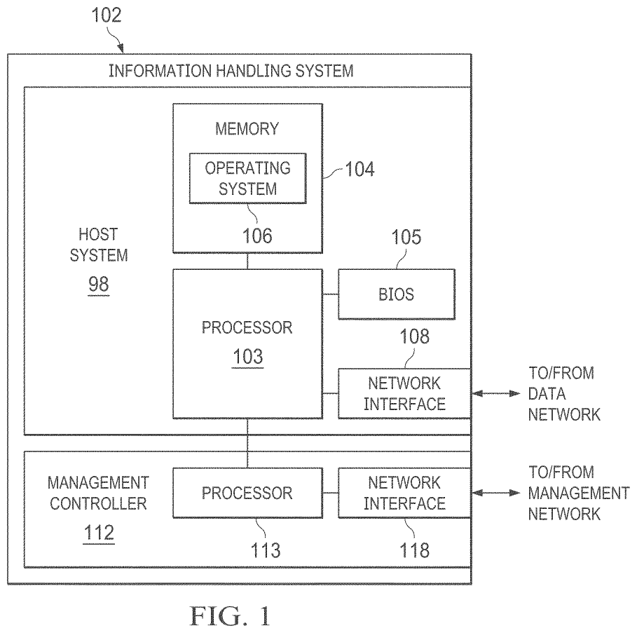

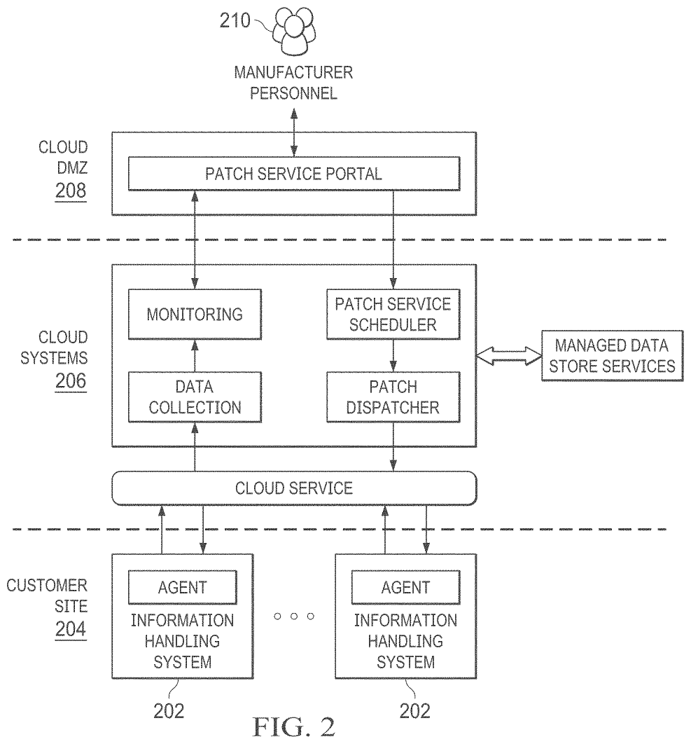

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102 (e.g., by a user operating a management console). Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may provide simpler and more efficient updating of information handling system services (e.g., microservices), particularly in an HCI environment. In particular, in some embodiments a plugin distribution system may be used to deliver product patch plugins to customer environments by leveraging a cloud-based secure channel between the manufacturer of information handling systems and various customer sites. For purposes of this disclosure, a manufacturer of an information handling system may refer to an original equipment manufacturer (OEM), distributor, wholesaler, retailer, etc., or in general any party that produces updates for an information handling system after it has been deployed to a customer site. Further, for purposes of this disclosure, a patch plugin may refer to any package for updating software, firmware, etc.

Patch plugins may be delivered dynamically in some embodiments, based on customer environment runtime status. Further, in some embodiments they may may also be deployed automatically without customer/support personnel intervention.

Accordingly, product patch plugins may be delivered quickly to a customer environment, with or without human intervention. A cloud-based, secure transfer channel may be used for such delivery, allowing access-controlled and audited patch delivery and deployment. Thus embodiments may significantly reduce the time required for a software delivery cycle, improving customer environment quality and satisfaction.

Turning now to FIG. 2, a block diagram is shown of an update distribution system, in accordance with some embodiments. As shown in FIG. 2, a patch service portal may be implemented within a cloud DMZ 208 of a management system. The patch service portal may provide portal access to a cloud-based patch distribution system, including access to systems for monitoring and reporting patch events. In some embodiments, cloud DMZ 208 may provide secure access to one or more systems in cloud systems 206 which implement various features according to this disclosure. Manufacturer personnel 210 may access such systems via the patch service portal in order to provide new patches, manage the rollout of patches, etc. The patch service portal may in some embodiments implement role-based access control, patch scheduling, and audited operations.

Within cloud systems 206, a monitoring subsystem may monitor the runtime status of one or more customer environments, including customer site 204. In some embodiments, the monitoring subsystem may use a data collection subsystem for accessing information about customer site 204. The monitoring subsystem may use such information to detect any target clusters that may need to be patched.

A patch service scheduler subsystem may then determine convenient times for patches to be deployed to the various information handling systems 202 within customer site 204. A patch dispatcher subsystem may then distribute such patches through a secure transfer channel.

In some embodiments, cloud systems 206 may include one or more managed data store services (e.g., databases), as well as various third-party services to implement some portions of the functionality described herein.

At customer site 204, information handling systems 202 may be configured to receive the updates from the cloud service executing within cloud systems 206. In some embodiments, information handling systems 202 may execute a software agent which, in operation, is configured to receive patch plugins from the cloud service, deploy the patches automatically without human intervention, and report back with status updates regarding the dispatching and deployment status.

As noted above, embodiments of this disclosure may have particular application in the field of microservices running on HCI clusters. For example, if the monitoring subsystem determines that customer site 204 is running a microservice version X that needs to be updated to version Y, the microservice may be updated incrementally according to this disclosure.

That is, version X may continue running and servicing requests (e.g., on some individual information handling systems or virtualized information handling systems) while version Y is being deployed. If there are any problems with the upgrade, it may be rolled back. If not, the deployment may continue with both versions running concurrently in different systems, and version Y may gradually supplant version X on the production system.

Such a microservice upgrade deployment may be contrasted with existing systems in which an upgrade is deployed first to a “staging” environment for testing and eventually deployed to the “production” environment all at once. Further, embodiments of this disclosure may allow for very targeted and customized versions of a microservice to be deployed. For example, a particular customer may have need of a feature or bug fix that other customers do not need. A customized version of the microservice may be incrementally rolled out to that customer site only, as discussed above.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
at least one processor; and
a non-transitory memory coupled to the at least one processor;
wherein the information handling system is configured to:
provide an administrator with access to a patch management system via a patch service portal;
receive information from a target datacenter regarding a particular item of software executing at the target datacenter;
based on the received information, determine that an upgrade from an existing version to a new version of the particular item of software is available; and
deploy the upgrade from the patch management system to a selected subset of information handling systems within the target datacenter, such that the selected subset is upgraded to the new version, and such that a non-selected subset of the information handling systems within the target datacenter continues executing the existing version.

2. The information handling system of claim 1, wherein the particular item of software is a microservice.

3. The information handling system of claim 2, wherein the upgrade comprises a replacement of the microservice.

4. The information handling system of claim 1, wherein the target datacenter comprises a hyper-converged infrastructure (HCI) cluster.

5. The information handling system of claim 1, wherein the existing version and the new version comprise a common interface, such that the selected subset and the non-selected subset are configured to interoperate with one another.

6. The information handling system of claim 1, further configured to receive the upgrade from an administrator via the patch service portal.

7. The information handling system of claim 1, wherein the patch service portal executes within a demilitarized zone (DMZ) of a cloud system.

8. The information handling system of claim 1, wherein, in response to a detected problem with the new version, the information handling system is configured to roll back the upgrade on the selected subset.

9. A method comprising:
an information handling system providing an administrator with access to a patch management system via a patch service portal;
the information handling system receiving information from a target datacenter regarding a particular item of software executing at the target datacenter;
based on the received information, the information handling system determining that an upgrade from an existing version to a new version of the particular item of software is available; and
the information handling system deploying the upgrade from the patch management system to a selected subset of information handling systems within the target datacenter, such that the selected subset is upgraded to the new version, and such that a non-selected subset of the information handling systems within the target datacenter continues executing the existing version.

10. The method of claim 9, further comprising: in response to an administrator instruction, subsequently deploying the upgrade from the patch management system to the non-selected subset.

11. The method of claim 9, wherein the particular item of software is a microservice.

12. The method of claim 9, wherein the target datacenter comprises a hyper-converged infrastructure (HCI) cluster.

13. An article of manufacture comprising a non-transitory, computer-readable medium having computer-executable code thereon that is executable by an information handling system for:
providing an administrator with access to a patch management system via a patch service portal;
receiving information from a target datacenter regarding a particular item of software executing at the target datacenter;
based on the received information, determining that an upgrade from an existing version to a new version of the particular item of software is available; and
deploying the upgrade from the patch management system to a selected subset of information handling systems within the target datacenter, such that the selected subset is upgraded to the new version, and such that a non-selected subset of the information handling systems within the target datacenter continues executing the existing version.

14. The article of claim 13, wherein the particular item of software is a microservice.

15. The article of claim 14, wherein the upgrade comprises a replacement of the microservice.

16. The article of claim 13, wherein the target datacenter comprises a hyper-converged infrastructure (HCI) cluster.

17. The article of claim 13, wherein the existing version and the new version comprise a common interface, such that the selected subset and the non-selected subset are configured to interoperate with one another.

18. The article of claim 13, wherein the code is further for receiving the upgrade from an administrator via the patch service portal.

19. The article of claim 13, wherein the patch service portal executes within a demilitarized zone (DMZ) of a cloud system.

20. The article of claim 13, wherein, in response to a detected problem with the new version, the information handling system is configured to roll back the upgrade on the selected subset.
